(19) United States
(12) Patent Application Publication
(10) Pub. No.: US 2015/0102037 A1
(43) Pub. Date: Apr. 16, 2015

(54) SINGLE-LAYER COMPOSITE PRESSURE VESSEL

(71) Applicants: Francesco Nettis, London (GB); Brian Spencer, Sacramento, CA (US); Zachary Spencer, Sacramento, CA (US)

(72) Inventors: Francesco Nettis, London (GB); Brian Spencer, Sacramento, CA (US); Zachary Spencer, Sacramento, CA (US)

(21) Appl. No.: 14/362,580

(22) PCT Filed: Dec. 5, 2011
(86) PCT No.: PCT/EP2011/071814

§ 371 Date: Dec. 18, 2014

(51) Int. Cl. F17C 1/16; B29C 70/30; B29D 22/00

(52) U.S. Cl. CPC F17C 1/16; B29D 22/00; B29C 70/30
USPC 220/560.04; 156/189

(57) ABSTRACT

This invention is directed to a polymeric pressure vessel comprising a wall prepared by living polymerization such that the wall comprises a single layer of polymer having two sub-layers, an inner sub-layer that is not a composite and an outer layer that is.

### FIELD

This invention relates to composite pressure vessels comprising a single-layer polymeric matrix. The vessels are intended for use in the containment and transport of compressed fluids.

### BACKGROUND

The detrimental effects of the burning of fossil fuels on the environment are becoming more and more of a concern and have spurred great interest in alternative energy sources. While progress is being made with solar, wind, nuclear, geothermal, and other energy sources, it is quite clear that the widespread availability of economical alternate energy sources, in particular for high energy use applications, remains an elusive target. In the meantime, fossil fuels are forecast to dominate the energy market for the foreseeable future. Among the fossil fuels, natural gas is the cleanest burning and therefore the clear choice for energy production. There is, therefore, a movement afoot to supplement or supplant, as much as possible, other fossil fuels such as coal and petroleum with natural gas as the world becomes more conscious of the environmental repercussions of burning fossil fuels. Unfortunately, much of world's natural gas deposits exist in remote, difficult to access regions of the planet. Terrain and geopolitical factors render it extremely difficult to reliably and economically extract the natural gas from these regions. The use of pipelines and overland transport has been evaluated, in some instances attempted, and found to be uneconomical. Interestingly, a large portion of the earth's remote natural gas reserves is located in relatively close proximity to the oceans and other bodies of water having ready access to the oceans. Thus, marine transport of natural gas from the remote locations would appear to be an obvious solution. The problem with marine transport of natural gas lies largely in the economics. Ocean-going vessels can carry just so much laden weight and the cost of shipping by sea reflects this fact, the cost being calculated on the total weight being shipped, that is, the weight of the product plus the weight of the container vessel in which the product is being shipped. If the net weight of the product is low compared to the tare weight of the shipping container, the cost of shipping per unit mass of product becomes prohibitive. This is particularly true of the transport of compressed fluids, which conventionally are transported in steel cylinders that are extremely heavy compared to weight of contained fluid. This problem has been ameliorated somewhat by the advent of Type III and Type IV pressure vessels. Type III pressure vessels are comprised of a relatively thin metal liner that is wound with a filamentous composite wrap, which results in a vessel with the strength of a steel vessel at a substantial saving in overall vessel weight. Type IV pressure vessels comprise a polymeric liner that is likewise wrapped with a composite filamentous material. Type IV pressure vessels are the lightest of all the presently approved pressure vessels. The use of Type III and Type IV vessels coupled with the trend to make these vessels very large—cylindrical vessels 18 meters in length and 2.5-3.0 meters in diameter are currently being fabricated and vessel 30 or more meters in length and 6 or more meters in diameter are contemplated—has resulted in a major step forward in optimizing the economics of ocean transport of compressed fluids.

What would still be beneficial would be pressure vessels even lighter than Type III and Type IV vessels. The instant invention provides such a lighter pressure vessel and methods for its fabrication.

### SUMMARY

Thus, in one aspect this invention is directed to a pressure vessel, comprising: a single-layer polymeric construct comprising an inner sub-layer and an outer sub-layer wherein:
the inner sub-layer is in contact with, is inert to, and is impenetrable by, a fluid contained in the pressure vessel;
the outer sub-layer comprises a composite comprising a filamentous material that is hoop wound, isotensoidally wound or a combination of hoop and isotensoidally wound onto the inner sub-layer; and
   the inner and outer sub-layers comprise a continuous polymeric matrix.

In an aspect of this invention, the polymeric matrix is selected from the group consisting of polyolefin resins, vinyl ester resins, dicyclopentadiene resins and combinations thereof.

In an aspect of this invention, the polymeric matrix is formed of a prepolymer composition that comprises discyclopentadiene that is at least 92% pure.

In an aspect of this invention, the filamentous material is selected from the group consisting of metal filaments, ceramic filaments, natural filaments, glass filaments, carbon filaments, aramid filaments, ultra-high molecular weight polyethylene filaments and combinations thereof.

In an aspect of this invention, the filamentous material is selected from the group consisting of glass filaments and carbon filaments.

In an aspect of this invention, the contained fluid is compressed natural gas, CNG.

In an aspect of this invention, the compressed natural gas is raw natural gas.

In an aspect of this invention, the pressure vessel is spheroidal, oblate spheroidal, cylindrical or toroidal.

An aspect of this invention relates to a method of fabricating a pressure vessel, comprising:

providing a collapsible mandrel in the desired shape of the pressure vessel;
coupling a boss to the mandrel;
depositing a prepolymer formulation onto the mandrel/boss to a selected thickness;
initiating living polymerization of the prepolymer formulation;
winding a filamentous material over the polymerized prepolymer formulation in a hoop, isotensoid or a combination of hoop and isotensoid patterns; wherein
the filamentous material is dry-wound and then impregnated with the prepolymer formulation; or
the filamentous material is impregnated with the prepolymer formulation and then wound over the living polymer matrix;
   reinitiating polymerization;
   terminating polymerization; and,
   removing the collapsible mandrel.

In an aspect of this invention, in the above method, the boss is a composite boss.

In an aspect of this invention, in the above method, the collapsible mandrel comprises compressed sand.

In an aspect of this invention, in the above method, the collapsible mandrel comprises an inflatable/deflatable construct.

In an aspect of this invention, in the above method, the collapsible mandrel comprises a meltable substance.

In an aspect of this invention, in the above method. the meltable substance is selected from the group consisting of ice, a low-melting polymer and a low-melting metal.

In an aspect of this invention, in the above method, the collapsible mandrel comprises a pliable surface supported by removable scaffolding.

In an aspect of this invention, in the above method, the mandrel has a cylindrical center section and domed end sections, the composite boss being disposed in a polar orientation at least at one of the domes of the mandrel.

In an aspect of this invention, in the above method, the mandrel is spherical with the composite boss being disposed at a selected position on the sphere.

In an aspect of this invention, in the above method, the mandrel is an oblate spheroid, the composite boss being disposed in a polar orientation at one of both flattened ends of the spheroid.

In an aspect of this invention, in the above method, the mandrel is toroidal, the composite boss being disposed on an inner curvature of the torus.

### DETAILED DESCRIPTION

### Brief Description of the Figures

These figures are offered solely for the purpose of aiding in the understanding of this invention. They are not intended nor are they to be construed as limiting the scope of the invention in any manner whatsoever.

FIG. 1 shows isometric projections of various types of pressure vessels. The vessels are shown with an aperture into which a boss would be fitted for completion of the vessel.

FIG. 1A shows a spherical pressure vessel.

FIG. 1B shows and oblate spheroid pressure vessel.

FIG. 1C shows a toroidal pressure vessel

FIG. 1D shows a pressure vessel with a cylindrical center section and one domed end section

FIG. 1E shows a pressure vessel with a cylindrical center section and two domed end sections.

FIG. 2 shows a schematic representation of a single-layer pressure vessel of this invention.

FIG. 3 shows a schematic representation of a composite boss.

FIG. 4 shows a schematic representation of a solid mandrel/composite boss assembly.

### DISCUSSION

It is understood that, with regard to this description and the appended claims, any reference to any aspect of this invention made in the singular includes the plural and vice versa unless it is expressly stated or unambiguously clear from the context that such is not intended.

As used herein, any term of approximation such as, without limitation, near, about, approximately, substantially, essentially and the like, means that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise.

The terms “proximal” and “distal” simply refer to the opposite ends of a construct and are used as a method of orienting the features of an object with regard to one another or in relation to another object, e.g., the features of a boss and the position of the parts of the boss with regard to a vessel liner. In general, which end is designated as proximal and which is designated as distal is purely arbitrary unless the context unambiguously expresses otherwise.

As used herein, the use of “preferred,” “preferably,” or “more preferred,” and the like refers to preferences as they existed at the time of filing of this patent application.

As used herein, “contiguous” refers to two surfaces that are adjacent and that are in direct contact or that would be in direct contact were it not for an intervening layer of another material such as a shear ply.

As used herein, “impermeable” or “impervious” refers to the property of a substance that renders it substantially impossible for a fluid to penetrate to any significant degree into a surface formed of the first substance.

As used herein, “inert” refers to the property of a substance that renders a surface formed of the substance chemically unreactive toward any components of a fluid that may be contacted with the surface.

As used herein, a “fluid” refers to a gas, a liquid or a mixture of gas and liquid. For example, without limitation, natural gas as it is extracted from the ground and transported to a processing center is often a mixture of the gas with liquid contaminants. Such mixture would constitute a fluid for the purposes of this invention.

As used herein, a “wrap” or “over-wrap” refers to the winding of a filamentous material around a construct, which may be, without limitation, cylindrical, geodesic, toroidal, spherical, oblate spheroidal, etc. The filamentous material may be wound around the construct in a dry state and left as such or it may subsequently be impregnated with and embedded in polymeric matrix. Alternatively, the filamentous material impregnated with a polymeric matrix prior to being wound onto a construct in which case it also becomes embedded in excess matrix material.

Pressure vessels for the transport of compressed fluids, such as compressed natural gas, CNG, presently constitute four regulatory agency approved classes, all of which are cylindrical with one or two domed ends:

Type I. Comprises all metal, usually aluminum or steel. This type of vessel is inexpensive but is very heavy in relation to the other classes of vessels. Although Type I pressure vessels currently comprise a large portion of the containers used to ship compressed fluids by sea, their use in marine transport incurs very tight economic constraints.

Type II. Comprises a thinner metal cylindrical center section with standard thickness metal end domes in which only the cylindrical portion is reinforced with a composite wrap. The composite wrap generally constitutes glass or carbon filament impregnated with a polymer matrix. The composite is usually “hoop wrapped” around the middle of the vessel. The domes at one or both ends of the vessel are not composite wrapped. In Class II pressure vessels, the metal liner withstands about 50% of the stress and the composite withstands about 50% of the stress resulting from the internal pressure of the contained compressed fluid. Class II vessels are lighter than Class I vessels but are more expensive.

Type III. Comprises a thin metal liner that constitutes the entire structure wherein the liner is reinforced with a filamentous composite wrap around entire vessel. The stress in Type III vessels is shifted virtually entirely to the filamentous material of the composite wrap; the liner need only withstand a small portion of the stress. Type III vessels are much lighter than type I or II vessels but are substantially more expensive.

Type IV. Comprises a polymeric essentially gas-tight liner fully wrapped with a filamentous composite. The composite wrap provides the entire strength of the vessel. Type IV vessels are by far the lightest of the four approved classes of pressure vessels but are also the most expensive.

All pressure vessels require at least one end fitting, called a “boss,” for connecting the vessel to external paraphernalia for loading and unloading fluids into and out of the vessel. Bosses in current use are generally made of metals such as stainless steel, nickel alloys, aluminum, brass and the like. Unfortunately, bosses, in particular with regard to larger pressure vessels, are extremely heavy, by some estimations comprising as much as 70% of the weight of a Type III or Type IV pressure vessel. Further, large metal bosses are difficult to manufacture and tend to be expensive, often costing $100,000 or more. These factors have a huge negative effect on the economics, and thereby the viability, of ocean transport of compressed fluids. A polymeric composite boss would substantially lighten any of the classes of vessels, in particular Type III and Type IV vessels. In co-pending patent application Ser. No. ______, which is incorporated by reference as if fully set forth here herein, such a composite boss is disclosed. With composite bosses in hand, all that remains with regard to further improving the weight ratio of contained fluid to container and thereby improve the economics of marine transport of compressed fluids is the weight of the pressure vessel itself. One approach to further reducing pressure vessel weight would be to eliminate the liner by forming the vessel of a single layer of material. This concept is not entirely new. Versions of such a pressure vessel are presently known and, in fact, are generally referred to as “Type V” pressure vessels, although they have yet to be formally approved by regulatory agencies and officially given the “Type V” designation. Existing Type V vessels, however, are single-layer polymeric constructs in which the entire construct consists of a composite comprising a polymeric matrix with a strength-enhancing fibrous or filamentous material disposed substantially uniformly throughout the matrix. These Type V vessels attempt to emulate the desirable characteristics of a Type IV vessel, i.e., liner plus overlaid composite, by using a matrix polymer that has the requisite properties of a liner such as inertness and impenetrability. The problem is that, by definition, a composite comprises two or more constituent materials with significantly different physical and chemical properties, which materials therefore remain separate and distinct at both the macroscopic and microscopic levels within a finished structure. This means that the structure is inherently permeable to fluids at the junctions of filamentous material and matrix polymer when the filamentous material is at the surface of a layer of composite. Further, whenever very different materials are combined there is always the opportunity for flaws in the overall structure. For example, bubbles may form at the intersection of the filamentous material and the polymeric matrix and the bubbles could create a channel through a composite coating which might compromise the impenetrability of the structure as well as affect its strength. Or the filamentous material and the polymer may separate under stress conditions, which could lead to total failure of the vessel. The present invention solves the problem by using a thin layer of an inert and impenetrable matrix polymer that contains no fibrous or filamentous material, i.e., it is not a composite, as an inner sub-layer. The matrix polymer is formed from a prepolymer formulation. An outer sub-layer of a filamentous material is then wrapped over the inner sub-layer. The filamentous material is either dry-wrapped over the inner sub-layer and then impregnated with the same prepolymer formulation as that used for the inner sub-layer or the filamentous material is first impregnated with the prepolymer formulation and then applied to the inner sub-layer. In either case, the matrix polymer formed by curing the prepolymer formulation is merged into a single polymeric entity for both the inner and outer sub-layers; that is, there is no discernable physical separation between the inner sublayer, which is impervious and inert, and the outer sub-layer, which is a composite.

The present invention also addresses another problem that has at times been observed with Type IV pressure vessels. If a conventional liner is made of a different polymer than that of the composite over-wrap, which is often the case, the polymers will virtually assuredly have different physical properties in terms of thermal expansion and contraction and reaction to stress and strain. In a pressure vessel, which in use is subject to extremes of stress and strain and sometimes temperature, this can result in delamination at the boundary between the liner and the composite layers followed by failure of the liner and subsequent exposure of the composite layer to the fluid contained in the pressure vessel. As discussed above, the composite might be neither inert to nor impenetrable by the fluid in that, with an intact liner in place, it simply did not have to be. This, again, could result in catastrophic failure of the vessel.

The instant invention, on the other hand, comprises a single-layer construct pressure vessel; that is, the construct has no intersection, no physical dividing line between the essentially pure matrix polymer of an inner sub-layer, which is equivalent to a “liner.” and the matrix polymer of the composite outer sub-layer. This is accomplished by using controlled polymerization, sometimes referred to as “living polymerization,” to fabricate the vessel.

For the purpose of this disclosure, “controlled” polymerization and “living” polymerization are used interchangeably. Living polymerization is well-known in the polymer art and need not be exhaustively described herein. In brief, it is understood that in standard polymerization reactions chain termination and chain transfer competes with chain extension. Eventually, all growing polymer chains become end-capped with unreactive groups, resulting in unrecoverable cessation of the polymerization reaction. In a living polymerization on the other hand the ability of growing polymer chains to undergo chain termination and chain transfer is removed so that polymerization ceases only when all monomer or prepolymer has been consumed. The end groups of the polymer chains remain in a latent reactive state. So long as the polymerization catalyst (the term “polymerization initiator” is sometimes used in the art; for the purpose of this invention, the terms are considered synonymous and interchangeable) remains in the polymer mixture and so long as it remains active, as soon as more monomer or prepolymer is added to the latent reactive polymer/initiator mixture, polymerization begins anew, the existing chains being further lengthened by addition of monomer or prepolymer and new chains being formed. The result is a new composition that is physically and chemically indistinguishable from the initial composition except that individual polymer chains tend to be substantially longer. As an ancillary benefit of living polymerization, the rate of chain initiation is usually much larger than the rate of chain propagation. This results in a polymerization that provides polymers of extremely narrow polydispersity (the weight average molecular weight divided by the number average molecular weight), i.e. chains of virtually identical length. This can be beneficial because polymers with narrow polydispersity generally exhibit very uniform physical properties, a desirable characteristic for a polymer which is to be subjected to the extreme conditions encountered in pressure vessel use, especially compressed natural gas (CNG) applications where the pressure may be in excess of 250 bar.

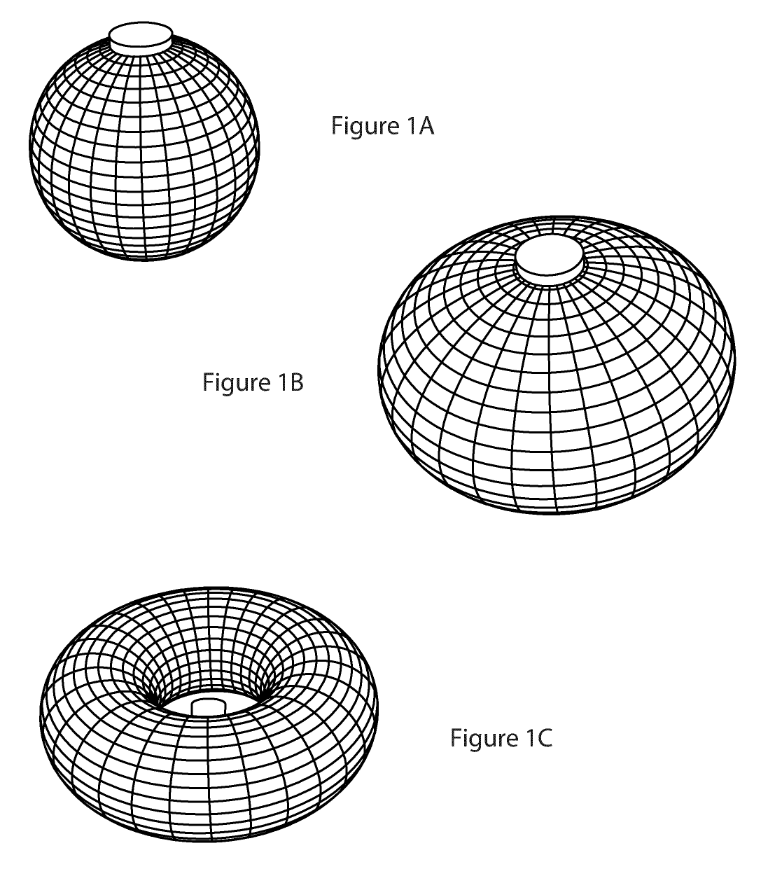

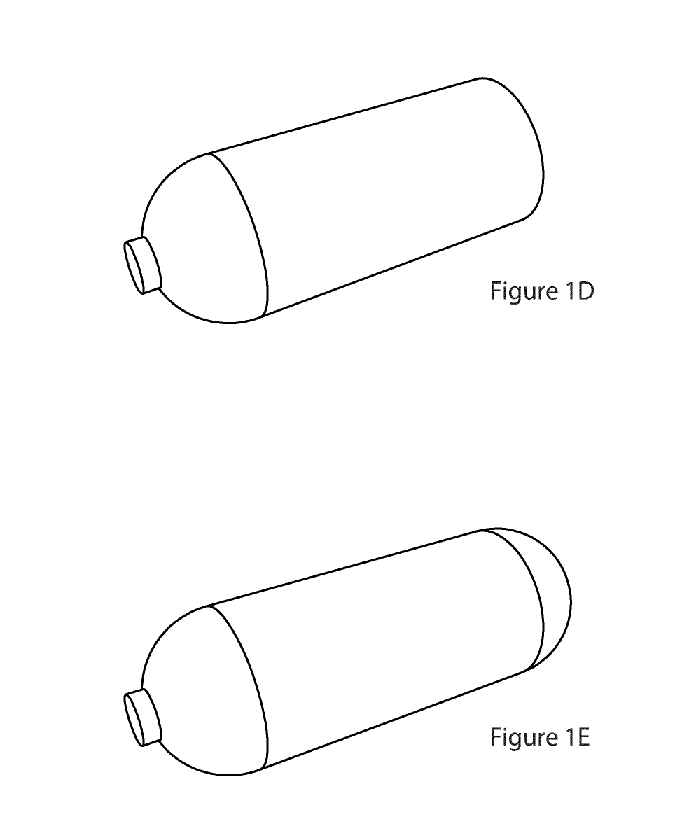

As used herein, a “pressure vessel” refers to any closed container designed to hold fluids at a pressure substantially different from ambient pressure. In particular at present, it refers to such containers used to hold and transport CNG. Pressure vessels may take a variety of shapes but most often seen in actual use are spherical, oblate spheroidal, toroidal and vessels with cylindrical center sections and one or two domed end sections as illustrated in FIG. 1. For the purpose of this disclosure, the latter of theses vessel shapes will be referred to simply as “cylindrical,” it being understood that the vessel also include one or two domed end sections as illustrated in FIGS. 1D and 1E. Vessel sizes may also vary tremendously from very small laboratory vessels to vessels for use in alternative fuel vehicles to vessels of the size contemplated herein for the marine transport of compressed fluids. Any size vessel comprising a single-layer wall is within the scope of this invention. In a presently preferred embodiment, the construct and methods of this invention are used to fabricate very large pressure vessels for the transportation of CNG.

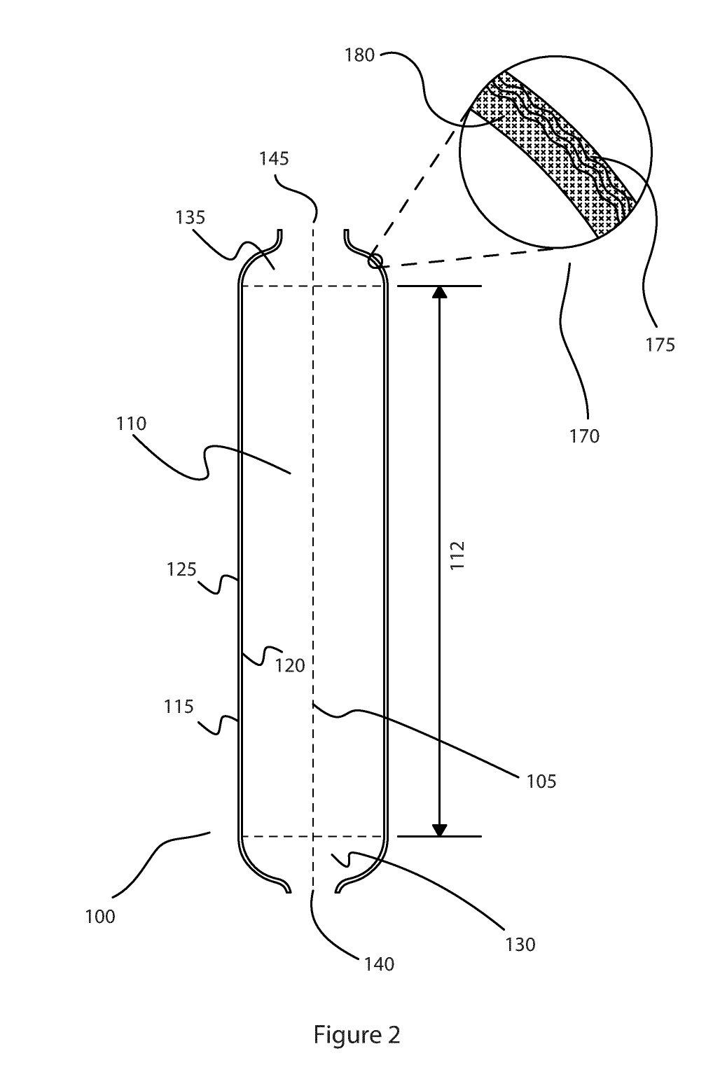

Single-layer pressure vessels of this invention may have any of the above-mentioned shapes, i.e., spherical, oblate spheroidal, toroidal or cylindrical or any other shape that may be found to be useful for the containment and transport of compressed fluids. For the purposes of this disclosure only a single-layer cylindrical pressure vessel, such as that shown in FIG. 2, will be discussed in any detail. The skilled artisan will, however, be readily able to apply the teachings herein to form pressure vessels of any desired shape.

In FIG. 2, pressure vessel 100 comprises cylindrical center section 110 having length 112, outer surface 115, inner surface 120, thickness 125, domes 130 and 135 and polar openings 140 and 145. As mentioned previously, it is entirely possible and within the scope of this invention that a pressure vessel of this invention may comprise a polar opening in only one of the domes. Also within the scope of this invention is a pressure vessel in which length 112 of cylindrical center section 110 approaches zero, the result being a substantially spherical pressure vessel.

A pressure vessel of this invention comprises, as noted previously, a single-layer polymeric construct. By “single-layer” is meant that the wall of the vessel comprises one unified layer of matrix polymer, which under macroscopic or microscopic examination would appear as a single continuous mass of polymer. In other words, there is no discernable discontinuity in the polymeric matrix layer. This continuous mass of polymer does, however, comprise two sub-layers. An inner sub-layer is comprised essentially of just the matrix polymer, that is, no filamentous material is present. The outer sub-layer, on the other hand, is comprised of the matrix polymer with a filamentous material embedded therein so as to create a composite that provides the vessel with its ultimate strength.

An illustrative single-ply construct is illustrated in detail 170 of FIG. 2 wherein the region with crosses signifies the matrix polymer fraction, which can be seen to comprise the entire underlying structure. The wavy lines indicate filamentous material embedded in the matrix polymer but only in outer sub-layer 175. Inner sub-layer 180 of FIG. 2 essentially comprises matrix polymer alone. By “essentially comprises matrix polymer alone” is meant that there is no filamentous material in the inner sub-layer. There may be, however, other materials contained therein such as antioxidants, polymerization rate modifiers and other excipients so long as the excipients do not affect the integrity, i.e. impenetrability and inertness to contained fluid, of the inner layer.

Any polymer that can be synthesized by living polymerization can be used in the method of this invention to fabricate a one-layer pressure vessel so long as the polymer has the requisite physical and chemical characteristics required of a material to be used in conjunction with a particular fluid to be contained in the pressure vessel in terms of chemical inertness and physical impermeability to the fluid. Such polymers include, without limitation, polyolefin resins and vinyl ester resins. Presently preferred, however, are polydicyclopentadiene resins that are formed by living ring-opening metathesis polymerization (ROMP).

In particular, it is presently preferred that a dicyclopentadiene resin be prepared from a prepolymer formulation in which the dicyclopentadiene used is at least 92% pure, preferably at present at least 98% pure, are presently preferred.

As used herein, a “prepolymer formulation” refers to a blend of at least 92% pure dicyclopentadiene with one or more reactive ethylene monomer(s), a polymerization initiator or curing agent plus any other desirable additives prior to curing.

Living ROMP is well-known in the art and need not be described in detail herein. The same initiators well-known to those skilled in standard olefin metathesis can be used. Typical of such catalysts are, without limitation, Tebbe's reagent, a titanocene-based catalyst, Schrock tungsten, molybdenum and ruthenium catalysts and Grubbs ruthenium catalyst.

As mentioned above, the outer sub-layer of the single-layer pressure vessel of this invention comprises a composite comprising a filamentous material. The filamentous material can be comprised of, for example without limitation, single strands of material, multiple individual threads, which may remain as a bundle of separate threads or may be woven together into multi-thread strands, or it may be a filamentous tape, i.e. a construct having a cross-section with a width that is greater than its thickness.

The filamentous material is incorporated into the polymeric matrix in the same manner as it would be in a Type IV pressure vessel where it is applied over a liner. That is, the filamentous material is continuously wound around the inner sub-layer of the single layer after that sub-layer has been cured. If the pressure vessel is spherical or an oblate spheroid, the entire vessel is generally wound with the filamentous material in an isotensoidal pattern. If the pressure vessel is cylindrical, the vessel may be wound isotensoidally only or it may be hoop wound in its cylindrical section and isotensoidally wound in both its cylindrical and its domed end-cap sections. A toroidal vessel could be hoop-wrapped or isotensoidally wrapped or a combination thereof.

By “isotensoidal” is meant that each filament of the wrap experiences a constant pressure at all points in its path. As mentioned previously, the term “wrap” or “overwrap” is used herein to describe the end result of winding of a filamentous material around a pressure vessel shell. Isotensoidal winding—or an isotensoidal wrap or over-wrap—is currently considered to be the optimal design for a composite pressure vessel because, in this configuration, virtually the entire stress imposed on the vessel by a contained fluid under pressure is absorbed by the filaments of the composite with very little of the stress being assumed by the polymeric matrix.

By “hoop-wrapped” is meant that the filamentous material is wound around the vessel shell in a circumferential pattern. Both isotensoidal and hoop winding are well-known to those skilled in the art of Type II, Type III and Type IV pressure vessels and need not be further described here.

With regard to filamentous materials, any known material with the requisite strength properties or any such material that may become known in the future may be used as a component of the outer sub-layer of a Type V pressure vessel of this invention. Such materials presently include, without limitation, metal filaments, ceramic filaments, natural filaments (such as without limitation flax, hemp or cotton), glass filaments, e.g., fiberglass, carbon filaments, aramid filaments, sometimes referred to by the trade name Kevlar® and ultra-high molecular weight polyethylene filaments, such as those sold under the tradenames Spectra® (Honeywell Corporation) and Dyneeva® (Royal DSM N.V.). Combinations of these filamentous materials may also be used.

While a pressure vessel of this application can contain virtually any fluid so long at the matrix polymer of the vessel shell is selected to be inert to and impenetrable by the fluid, a presently preferred use of a pressure vessel herein is for the containment and transport of CNG.

CNG may be contained and transported in the vessels of this invention as a purified gas or as “raw gas.” Raw gas refers to natural gas as it comes, unprocessed, directly from the well. It contains, of course, the natural gas (methane) itself but also may contain liquids such as condensate, natural gasoline and liquefied petroleum gas. Water may also be present as may other fluids, either in the gaseous state or dissolved in the water, such as nitrogen, carbon dioxide, hydrogen sulfide and helium. Some of these may be reactive in their own right. Some may become reactive when dissolved in water, such as carbon dioxide and hydrogen sulfide, which produce an acidic environment when mixed with water. Such impurities must be kept in mind when deciding on a matrix polymer for use in the present invention. The presently preferred matrix polymer, ROMP dicyclopentadiene, has excellent properties with regard to chemical resistance (inertness) to the above, and other, materials that might constitute raw gas.

Single layer pressure vessels of this invention may be formed using standard techniques presently used in the art. That is, the inner sub-layer may be formed in the same manner as a convention liner by, for example, injection molding, compression molding and blow molding. Using these techniques, a stand-alone liner shell is produced as the inner sub-layer and then the outer sub-layer is applied to the inner sub-layer shell. There are two considerations that may affect the choice of conventional techniques for the construction of a single-layer vessel. First, the active life-span of the catalyst must be considered. Many catalysts tend to be moisture sensitive and are inactivated in a relatively short time when exposed to even atmospheric moisture. Thus, protection from such must be a consideration if creating a stand-alone liner shell.

In addition, the liner shell must be able to withstand the pressures applied to it during the application of the composite over-wrap. Thus, the liner shell will have a thickness dictated by the pressures to be applied and the properties of the liner material. In general, this will in most circumstances require the liner to have a substantial thickness while, when using the collapsible mandrel fabrication technique, discussed below, the liner may be quite thin and the overall thickness of the complete pressure vessel may be substantially thinner than a pressure vessel made by conventional procedures. Nevertheless, such is possible and is definitely within the scope of this invention.

It is presently preferred that pressure vessels of this invention be fabricated by a molding process in which a mandrel in the desired vessel shape is prepared and the polymeric matrix is applied to the mandrel. A critical aspect of the mandrel for use with this invention is that it be “collapsible.” By a “collapsible” mandrel is meant a mandrel that accurately represents the desired finished shape of the pressure vessel be it spherical, oblate spheroidal, toroidal, cylindrical or otherwise, but that, upon completion of the molding process, is capable of being removed through an opening in the fully formed vessel that is typically much smaller than the largest dimension of the finished pressure vessel and obviously, therefore, that of the mandrel. With regard to pressure vessels of this invention, the opening is usually the polar opening shown on the vessels in FIG. 1.

Collapsible mandrels can be created in many ways some of which are presented below. Any and all techniques are within the scope of this invention, however, including those that might occur to those skilled in the art based on the disclosure herein. For example, without limitation, the mandrel may be created of compressed sand. Once the pressure vessel is formed over the sand mandrel, the mandrel may be removed through the polar opening by, without limitation, flushing it out with water or subjecting the vessel to vibrational energy to shake the compressed sand mandrel back into a flowable material.

The collapsible mandrel may also be created of a meltable substance. Such meltable substance can be, without limitation, ice, a low-melting polymer, a low-melting metal or any another substance that can interconvert between solid and liquid states at relatively low temperatures. By “relatively low temperatures” is meant any temperature at which it is determined that no detrimental effect to the matrix polymer of the pressure vessel will occur when the mandrel material is melted.

The collapsible mandrel may also comprise an inflatable/deflatable construct, in essence, a balloon. The balloon material need simply be one that can withstand the temperatures and pressures at which the pure matrix polymer inner sub-layer is applied as well as any residual pressure that might be exerted on the balloon when the composite outer sub-layer is formed. When the vessel is finished, the balloon is simply deflated and withdrawn through the polar opening of the pressure vessel. A balloon mandrel can generally be reused.

In another embodiment of this invention, the collapsible mandrel may comprise collapsible scaffolding over which a pliable surface material is fitted. The scaffolding must, of course, be designed such that, when collapsed, its maximum dimension is smaller than the dimension of the polar opening in the completed pressure vessel. The pliable surface material may be attached to the collapsible scaffold in such a manner that, when the scaffold is collapsed, rather than remaining adhered to the scaffold at many points so that it adds to the overall dimensions of the collapsed scaffold, it is attached only to the trailing end, that is, the end of the scaffold that will be withdrawn from the completed vessel last. In this manner, the pliable surface material can be extracted from the pressure vessel after the scaffold structure per se has been removed. The scaffold can then be reassembled and reused.

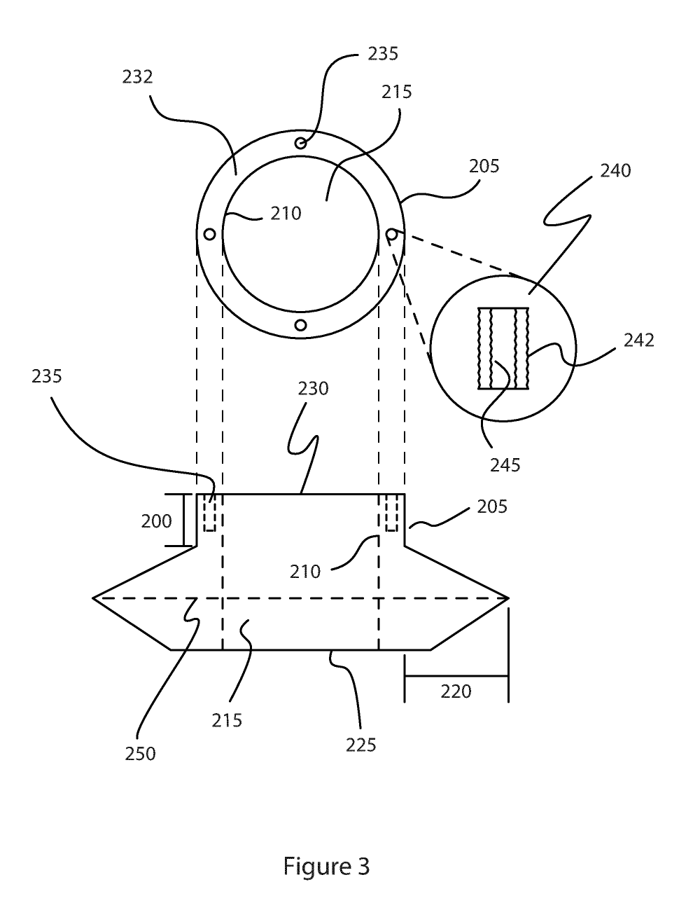

A further feature of a collapsible mandrel of this invention is that a boss may be coupled to the mandrel, possibly at both ends if the vessel is cylindrical, such that the pressure vessel is formed over both the mandrel and the boss. The technique is well-known in the art and is called “insert molding.” In insert molding, a plastic part is molded directly over or around a separate metal or another plastic part to create a one-piece assembly. The “plastic part” would herein be the pressure vessel itself and the “separate plastic part” would be the boss. The boss may be a conventional metal boss as is presently ubiquitous in the field. Preferably, however, the boss is a single piece composite boss, which, as noted above, is the subject of a co-pending patent application. A schematic representation of such a single piece composite boss is shown in FIG. 3.

In brief, in FIG. 3, the boss comprises tubular center section 200 having outer surface 205, inner surface 210, through-hole 215 and flange, sometimes referred to in the art as a “wing,” 220. For the purposes of description, the flange end of the boss will be considered to be its distal end, 225 in the figure, and the other end, naturally, will be considered the proximal end, 230 in the figure. Threaded holes 235 are radially disposed around proximal end surface 232. These threaded holes may be used directly to connect the boss to a flange piece that in turn is used to couple the vessel to an external line for loading and unloading the vessel. In a presently preferred alternative threaded holes 235 form a mating surface with a diameter that is larger than that required for use with the intended fasteners. Into these oversize holes metallic exteriorly-threaded (242) inserts 240 are screwed. The inserts comprise internal threads 245 that are sized correctly for coupling to whatever device is to be used to attach the pressure vessel to an external system for loading and unloading.

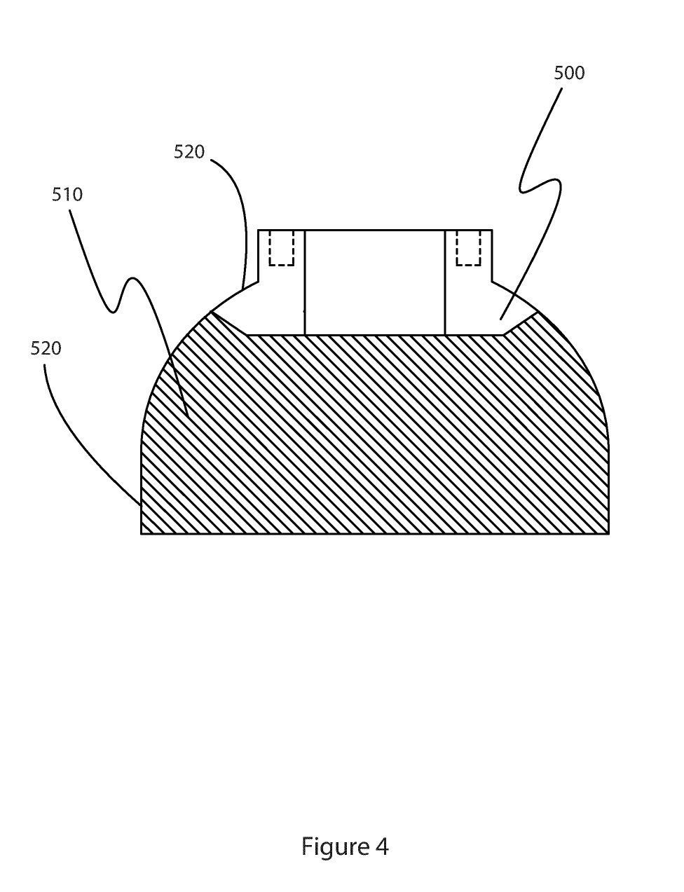

For fabrication of a cylindrical pressure vessel of this invention, a composite boss such as that illustrated in FIG. 3 is coupled in a polar orientation to one or both domed end-caps of the mandrel as shown in FIG. 4. Once the mandrel/boss template is formed, a prepolymer formulation, such as that discussed above, is deposited over the template to a selected thickness.

A catalyst is selected that will initiate polymerization of the prepolymer formulation at the selected curing conditions. The selected curing condition will depend on, without limitation, the nature of the polymerizable components of the prepolymer formulation and the desired curing temperature. With regard to the presently preferred prepolymer formulation of this invention, that is, one that comprises dicyclopentadiene, curing may be accomplished at ambient temperatures, which can be advantageous if the vessel is very large in that no controlled, heated environment need be provided, a substantial economic advantage. As used herein, “ambient temperature” simply refers to the temperature in the environs where application and curing of the prepolymer is to occur, wherein the environs is not heated specifically to achieve a suitable application and curing temperature. Generally, ambient temperatures are from about 55° F. to about 100° F., although the prepolymer formulation of this invention may be used at ambient temperatures both above and, particularly, well below this range. This avoids the need for special temperature-controlled environments, an exceedingly beneficial objective particularly when fabricating very large pressure vessels such as those described earlier.

Since polymerization in this invention necessarily comprises living polymerization, curing is conducted until essentially all of the polymerizable compounds in the prepolymer formulation have been consumed. The resulting cured sub-layer then comprises a living polymer matrix, that is, a polymer matrix comprising latent, active catalyst that is capable of re-initiating polymerization when and if additional polymerizable compounds are brought in contact with the cured sub-layer.

Once curing of the inner sub-layer has completed, the cured inner sub-layer is wound with a filamentous material. The filamentous material may be dry-wound or it may be impregnated with the prepolymer formulation. The winding may be applied in only an isotensoid pattern, which would be the case if the pressure vessel is spherical or oblate spheroid, or it may be a hoop winding followed by isotensoid winding or vice versa, which would be the case if the pressure vessel is cylindrical. Hoop winding may be omitted if desired with a cylindrical vessel such that the vessel is isotensiodally-wrapped only. Various wrapping patterns are known for toroidal pressure vessel and any of these may be used with the instant invention.

If the filamentous material is dry-wound onto the cured inner sub-layer, it may be left as such to form a dry-wound pressure vessel or it may be impregnated with the prepolymer formulation.

If the filamentous material is pre-impregnated with the prepolymer formulation, once wound on the inner sub-layer, either it is ready for curing or, if desired, additional prepolymer formulation may be applied over what is now the outer or composite sub-layer. Since the polymerization was specifically selected to be a living polymer-type polymerization and if the requisite care has been taken to not deactivate the polymerization catalyst (that which constitutes “requisite care,” such as protection from moisture, is well-known to those skilled in the art), polymerization automatically reinitiates upon contact of the added prepolymer composition with the living polymer of the inner sub-layer. The polymerizable components of the prepolymer composition simply add to the ends of the polymer strands comprising the cured inner sub-layer. In this manner, a continuous polymeric matrix comprising the polymer of the inner sub-layer and the polymer matrix of the composite outer sub-layer is formed.

When curing or polymerization has completed, polymerization may be terminated by deactivating the catalyst by any number techniques known to those skilled in the art or it may simply be left to slowly deactivate on contact with ambient moisture.

At this point, the collapsible mandrel is removed leaving a finished Type V pressure vessel.

A Type V pressure vessel of this invention can be used to contain and transport any type of fluid that is amenable to such transport and so long as the polymer selected for the inner sub-layer is impermeable/impenetrable and chemically inert to the contained compressed fluid.

A presently preferred use of a Type V pressure vessel of this invention is for the containment and transport of natural gas, often referred to as “compressed natural gas” or simply “CNG.”

CNG may be contained and transported in the vessels of this invention both as a purified gas and as “raw gas.” Raw gas refers to natural gas as it comes, unprocessed, directly from the well. It contains, of course, the natural gas (methane) itself but also may contain liquids such as condensate, natural gasoline and liquefied petroleum gas. Water may also be present as may other gases, either in the gaseous state or dissolved in the water, such as nitrogen, carbon dioxide, hydrogen sulfide and helium. Some of these may be reactive in their own right or may be reactive when dissolved in water, such as carbon dioxide and hydrogen sulfide which produces an acid when dissolved in water. The presently preferred inner sub-layer polymer, one based on a dicyclopentadiene prepolymer formulation comprising at least 92% pure dicyclopentadiene, will have excellent properties with regard to chemical resistance to the above, and other materials that might constitute raw gas. The pressure vessels described herein can carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state, and other impurities/species.

These and other features of the present invention may be used independently or in combination, within the scope of the claims and/or the present disclosure.

The present invention has therefore been described above purely by way of example. Modifications in detail may be made to the invention within the scope of the claims appended hereto.

1. A pressure vessel, comprising:
a single-layer polymeric construct comprising an inner sub-layer and an outer sub-layer wherein:
the inner sub-layer is in contact with, is inert to, and is impenetrable by, a fluid contained in the pressure vessel;
the outer sub-layer comprises a composite comprising a filamentous material that is hoop wound, isotensoidally wound or a combination of hoop and isotensoidally wound onto the inner sub-layer; and
the inner and outer sub-layers comprise a continuous polymeric matrix.

2. The pressure vessel of claim 1, wherein the polymeric matrix is selected from the group consisting of polyolefin resins, vinyl ester resins, dicyclopentadiene resins and combinations thereof.

3. The pressure vessel of claim 2, wherein the polymeric matrix is formed of a prepolymer composition that comprises discyclopentadiene that is at least 92% pure.

4. The pressure vessel of claim 1, wherein the filamentous material is selected from the group consisting of metal filaments, ceramic filaments, natural filaments, glass filaments, carbon filaments, aramid filaments, ultra-high molecular weight polyethylene filaments and combinations thereof.

5. (canceled)

6. The pressure vessel of claim 1, wherein the contained fluid is compressed natural gas, CNG.

7. The pressure vessel of claim 6, wherein the compressed natural gas is raw natural gas.

8. The pressure vessel of claim 1, wherein the pressure vessel is spheroidal, oblate spheroidal, cylindrical or toroidal.

9. A method of fabricating a pressure vessel, comprising:
providing a collapsible mandrel in the desired shape of the pressure vessel;
coupling a boss to the mandrel;
depositing a prepolymer formulation onto the mandrel/boss to a selected thickness;
initiating living polymerization of the prepolymer formulation;
winding a filamentous material over the polymerized prepolymer formulation in a hoop, isotensoid or a combination of hoop and isotensoid patterns; wherein
the filamentous material is dry-wound and then impregnated with the prepolymer formulation; or
the filamentous material is impregnated with the prepolymer formulation and then wound over the living polymer matrix;
reinitiating polymerization;
terminating polymerization; and,
removing the collapsible mandrel.

10. The method of claim 9, wherein the boss is a composite boss.

11. The method of claim 9, wherein the collapsible mandrel comprises compressed sand.

12. The method of claim 9, wherein the collapsible mandrel comprises an inflatable/deflatable construct.

13. The method of claim 9, wherein the collapsible mandrel comprises a meltable substance.

14. The method of claim 13, wherein the meltable substance is selected from the group consisting of ice, a low-melting polymer and a low-melting metal.

15. The method of claim 9, wherein the collapsible mandrel comprises a pliable surface supported by removable scaffolding.

16. The method of claim 10, wherein the mandrel has a cylindrical center section and domed end sections, the composite boss being disposed in a polar orientation at least at one of the domes of the mandrel.

17. The method of claim 10, wherein the mandrel is spherical with the composite boss being disposed at a selected position on the sphere.

18. The method of claim 10, wherein the mandrel is an oblate spheroid, the composite boss being disposed in a polar orientation at one of both flattened ends of the spheroid.

19. The method of claim 10, wherein the mandrel is toroidal, the composite boss being disposed on an inner curvature of the torus.

20. A pressure vessel formed using the method according to claim 9.

21. A ship comprising a pressure vessel according to claim 1.
